(19) United States
(12) Patent Application Publication
(10) Pub. No.: US 2026/0001183 A1
(43) Pub. Date: Jan. 1, 2026

(54) SUBSTRATE LOADING CASSETTE

(71) Applicant: Absolics Inc., Covington, GA (US)

(72) Inventors: Jae Won LEE, Covington, GA (US); Chaemook LIM, Covington, GA (US)

(73) Assignee: Absolics Inc., Covington, GA (US)

(21) Appl. No.: 19/239,992

(22) Filed: Jun. 17, 2025

Related U.S. Application Data
(60) Provisional application No. 63/664,185, filed on Jun. 26, 2024.

(51) Int. Cl. B23Q 7/10

(52) U.S. Cl. CPC B23Q 7/10

(57) ABSTRACT

Disclosed is a substrate loading cassette including an upper frame, a lower frame disposed to face the upper frame, a support frame configured to connect the upper frame and the lower frame to each other at an edge side of the substrate loading cassette, a transfer device coupling unit disposed on the upper frame, the transfer device coupling unit being coupled to a transfer device configured to transfer the substrate loading cassette, wherein the transfer device coupling unit includes a transfer device coupling frame and a vibration damping portion disposed under the transfer device coupling frame, the support frame includes a first support frame disposed on each of left and right sides of the substrate loading cassette and a second support frame disposed on a rear side of the substrate loading cassette, and the substrate loading cassette includes a support bar connected to the second support frame.

### CROSS-REFERENCE TO RELATED APPLICATION

This application claims the benefit under 35 U.S.C. 119(e) of U.S. provisional Patent Application No. 63/664,185 filed on Jun. 26, 2024 in the United States Patent and Trademark Office, the entire disclosure of which is incorporated herein by reference for all purposes.

### BACKGROUND

### 1. Technical Field

Embodiments relate to a substrate loading cassette.

### 2. Description of the Related Art

A cassette is used to transfer and store a plurality of substrates in a simple, accurate, and smooth manner. Generally, the cassette is configured such that a plurality of substrates is loaded in a frame that is open at one side in the state in which the substrates are disposed in multiple layers arranged in a vertical direction so as to be spaced apart from each other. The loaded substrates are unloaded from the cassette, are processed, and are loaded in the cassette again.

A glass substrate for semiconductor packaging is used as a high-end packaging substrate, wherein a plurality of vias is formed in a thin glass substrate such that the thin glass substrate can be used as a packaging substrate. The thin glass substrate may be inherently vulnerable to vibration and impact. In addition, a large-area glass substrate may experience sagging in the cassette due to the weight thereof, which may accelerate damage to the glass substrate.

The above information disclosed in this Background section is technical information that the inventors possessed to derive the present disclosure or acquired during the process of deriving the present disclosure, and does not form the prior art that was publicly disclosed to the general public before the filing of the present disclosure.

### SUMMARY

A substrate loading cassette according to an embodiment of the present disclosure includes an upper frame and a lower frame disposed so as to face the upper frame.

The substrate loading cassette includes a support frame formed in a vertical direction of the substrate loading cassette, the support frame being configured to connect the upper frame and the lower frame to each other at an edge side of the substrate loading cassette.

The substrate loading cassette includes a transfer device coupling unit disposed on the upper frame, the transfer device coupling unit being coupled to a transfer device configured to transfer the substrate loading cassette.

The transfer device coupling unit includes a transfer device coupling frame formed in a horizontal direction of the substrate loading cassette and a vibration damping portion disposed under the transfer device coupling frame.

The support frame includes a first support frame disposed on each of left and right sides of the substrate loading cassette and a second support frame disposed on a rear side of the substrate loading cassette.

The substrate loading cassette includes a support bar connected to the second support frame, the support bar having a shape extending inwardly of the substrate loading cassette.

The vibration damping portion includes polyamide resin.

The vibration damping portion has a compression strength of 600 kg/cm² or

more.

The support bar has a modulus of elasticity of 0.03 MPa to 0.5 MPa.

The support bar may have a Poisson's ratio of 0.4 or less.

The support bar may have a specific gravity of 1.2 to 1.8.

The vibration damping portion may have a tensile elastic modulus of 15,000 MPa to 50,000 MPa.

The transfer device coupling unit may further include a slip prevention portion disposed under the vibration damping portion.

The slip prevention portion may have a coefficient of friction higher than the coefficient of friction of the vibration damping portion.

The substrate loading cassette may include a substrate support unit connected to the first support frame, the substrate support unit being formed inwardly of the substrate loading cassette.

The substrate support unit may include a base portion and a protective layer formed so as to surround at least a part of the base portion.

The protective layer may include any one selected from a group consisting of polytetrafluoroethylene (PTFE), fluorinated ethylene propylene (FEP), polyetheretherketone (PEEK), polyetherimide (PEI), polyethersulfone (PES), perfluoroalkoxy copolymer (PFA), polyaryletherketone (PAEK), and a combination thereof.

The substrate loading cassette may include a guide block disposed on the upper frame.

The support bar may include a first end located on the second support frame side and a second end located on an opposite side to the first end.

The second end may be located higher than the first end.

The difference between the height of the second end when the support bar supports a target substrate and the height of the second end before the support bar supports the target substrate may be 3 mm or less.

The substrate loading cassette may include a substrate support member disposed on the support bar, the substrate support member protruding upward.

The substrate support member may have a convex shape.

### BRIEF DESCRIPTION OF THE DRAWINGS

FIG. 1 is a perspective view showing a substrate loading cassette according to an embodiment of the present disclosure;

FIG. 2A is a sectional view illustrating a transfer device coupling unit applied to the substrate loading cassette according to the embodiment of the present disclosure;

FIG. 2B is a sectional view showing the state in which the transfer device coupling unit is coupled to a gripping unit of a transfer device;

FIG. 2C is a sectional view illustrating a transfer device coupling unit applied to a substrate loading cassette according to another embodiment of the present disclosure;

FIG. 3 is a sectional view taken along line I-I′ in FIG. 1;

FIG. 4 is a side view showing a support bar of FIG. 1; and

FIG. 5 is a perspective view showing a substrate loading cassette according to a further embodiment of the present disclosure.

### DETAILED DESCRIPTION

Embodiments will be described in detail such that the embodiments can be easily implemented by a person having ordinary skill in the art to which the embodiments pertain. However, embodiments may be implemented in various other forms and are not limited to the embodiments described herein. Throughout the specification, similar parts are denoted by the same reference numerals.

Throughout this specification, the term “combination thereof” as used in a Markush-style representation is intended to mean at least one mixture or combination selected from the group of components described in the Markush-style representation, including one or more selected from the group of components.

Throughout this specification, terms such as “first” and “second” or “A” and “B” are used to distinguish one from another. In addition, singular forms are intended to include plural forms unless mentioned otherwise.

As used herein, reference to a “-” based may mean that a compound includes a compound corresponding to the “-” or a derivative of the “-”.

As used herein, reference to B being located on A means that B may be located on A in direct contact therewith or that B may be located on A in the state in which another layer is interposed therebetween, and is not to be construed as being limited to B being located on A in surface contact therewith.

As used herein, reference to B being connected to A means that B may be directly connected to A or that B may be connected to A in the state in which another layer is interposed therebetween, and is not to be construed as being limited to B being connected to A unless mentioned otherwise.

In this specification, singular expressions are construed to include singular forms or plural forms as interpreted from the context unless otherwise indicated.

In the drawings, the shapes, relative sizes, angles, etc. of the configurations are exemplary and may be exaggerated for purposes of illustration and shall not be construed as limiting the rights to the drawings.

In this specification, when A and B are adjacent, this means that A and B are tangential to each other or that A and B are not tangential to each other but are close to each other. In this specification, the expression “A and B are adjacent” shall not be construed to mean that A and B are tangential to each other unless otherwise indicated.

In this specification, the difference between A and B values refers to the absolute value of the difference between A and B values.

In this specification, “A-based resin” includes “A resin” and derivatives thereof. For example, aromatic polyether-based resin includes aromatic polyether resin and derivatives thereof (aromatic polyether copolymer resin).

Property values described in this specification are values measured at room temperature unless specified otherwise.

In a manufacturing environment including complex production lines in a limited space, a cassette loaded with substrates may be transferred by an overhead hoist transport (OHT), which is a transfer device installed on the ceiling of a manufacturing facility, in order to ensure efficient transfer of substrates. During a process of transferring the cassette by the OHT, especially during a process of lifting the cassette or moving the OHT loaded with the cassette along a rail installed on the ceiling, physical impact may occur on the substrates. As substrates to be loaded become more densely packed and thinner, the frequency and degree of damage to the substrates due to the impact may further increase.

The inventors of the present disclosure have applied technical features, such as introducing a vibration damping unit to a transfer device coupling unit in the cassette and controlling the mechanical properties of a support bar, to the cassette. As a result, the inventors have confirmed that it is possible to provide a substrate loading cassette capable of reliably suppressing damage to the loaded substrates during transfer by the OHT, and have completed the present disclosure.

Hereinafter, the embodiments will be described in detail.

### Frame

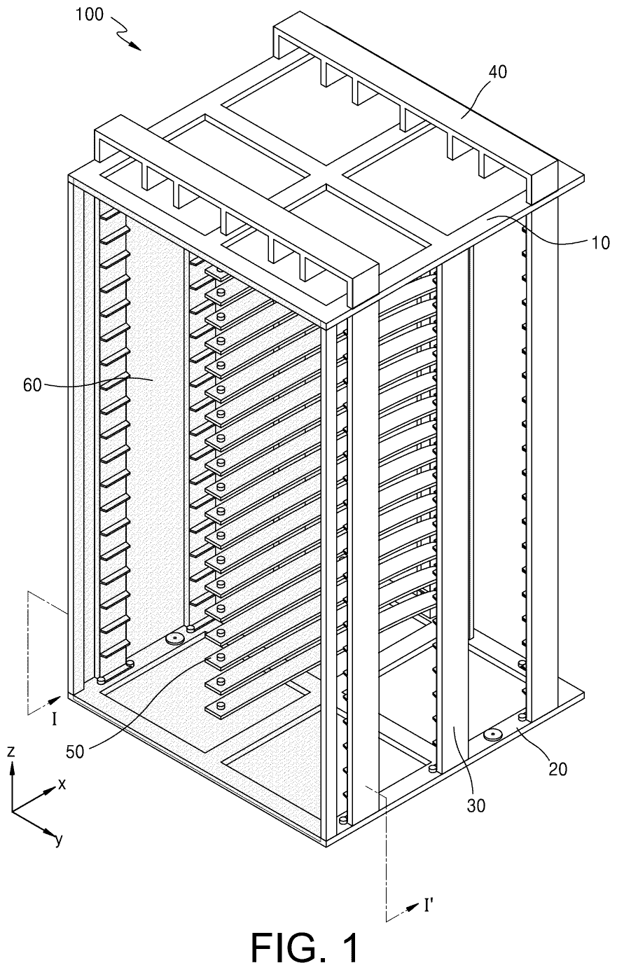

FIG. 1 is a perspective view showing a substrate loading cassette according to an embodiment of the present disclosure. The substrate loading cassette according to the embodiment will be described with reference to FIG. 1.

The substrate loading cassette 100 according to the present disclosure is configured to support and load target substrates.

The target substrate may be a glass substrate. For example, alkali borosilicate plate glass, alkali-free borosilicate plate glass, or alkali-free alkali earth-borosilicate plate glass may be used as the target substrate, and any plate glass for electronic components may be used. A glass substrate for electronic devices may be used as the target substrate.

The thickness of the target substrate may be 50 μm or more. The thickness of the target substrate may be 100 μm or more. The thickness of the target substrate may be 250 μm or more. The thickness of the target substrate may be 400 μm or more. The thickness of the target substrate may be 500 μm or more. The thickness of the target substrate may be 3,000 μm or less. The thickness of the target substrate may be 2,000 μm or less. The thickness of the target substrate may be 1,000 μm or less.

The target substrate may be a large-area substrate. The area of the target substrate may be 160,000 mm² or more. The area of the target substrate may be 180,000 mm² or more. The area of the target substrate may be 200,000 mm² or more. The area of the target substrate may be 500,000 mm² or less. The area of the target substrate may be 400,000 mm² or less.

The target substrate may include a core via formed through the substrate in a thickness direction. The core via may have a diameter that is substantially uniform in the thickness direction, or may have a diameter that varies in the thickness direction. The core via may include a first opening in contact with an upper surface of the target substrate, a second opening in contact with a lower surface of the target substrate, and a minimum inner diameter portion configured to connect the first opening and the second opening to each other, the minimum inner diameter portion being a region having the smallest inner diameter.

The substrate loading cassette 100 includes an upper frame 10 and a lower frame 20 disposed so as to face the upper frame 10.

Each of the upper frame 10 and the lower frame 20 is a frame disposed in a horizontal direction (x, y) of the substrate loading cassette. Each of the upper frame 10 and the lower frame 20 may be a matrix-shaped frame in which a bar-shaped frame is further formed in a square or rectangular frame.

The substrate loading cassette 100 may further include a support frame 30. The support frame 30 is a frame that is formed in a vertical direction of the substrate loading cassette to connect the upper frame 10 and the lower frame 20 to each other at an edge side of the substrate loading cassette. The support frame 30 may have a bar shape.

The support frame 30 may include a first support frame 31 disposed on each of left and right sides of the substrate loading cassette 100 and a second support frame 32 disposed on a rear side of the substrate loading cassette 100.

When the first support frame 31 has a bar shape, the substrate loading cassette 100 may include one to five first support frames 31 on each of the left and right sides thereof as needed.

The substrate loading cassette 100 may further include a second support frame 32 formed at a central portion of the rear side thereof. However, the substrate loading cassette 100 may further include two or more second support frames 32 as needed.

The material of each of the upper frame 10, the lower frame 20, and the support frame 30 is not limited as long as the material is generally used in the field of substrate loading cassettes, and, for example, aluminum or stainless steel may be used.

The substrate loading cassette 100 may further include a protective layer (not shown) configured to surround at least a part of the support frame 30. The protective layer may have adjusted elasticity and may prevent excessive physical damage to the substrates when the substrates collide with the support frame 30 during the process of loading the substrates or during the transfer of the cassette loaded with the cassettes.

The protective layer may surround the entire surface of the support frame 30. The protective layer may surround the part of the surface of the support frame 30 facing inwardly of the substrate loading cassette 100. The protective layer may be disposed in contact with the surface of the support frame 30. Other components may be disposed between the protective layer and the surface of the support frame 30.

The protective layer may include any one selected from the group consisting of polytetrafluoroethylene (PTFE), fluorinated ethylene propylene (FEP), polyetheretherketone (PEEK), polyetherimide (PEI), polyethersulfone (PES), perfluoroalkoxy copolymer (PFA), polyaryletherketone (PAEK), and a combination thereof. In this case, damage to the substrates loaded in the cassette by the support frame 30 may be prevented.

The protective layer may further include other additives in addition to the resin. The additives are not limited as long as the additives are commonly used in the field of resins. For example, a filler, a UV stabilizer, a heat stabilizer, an antioxidant, and a leveling agent may be used as the additives.

The support frame 30 may be disposed spaced apart from the target substrates loaded in the substrate loading cassette 100. Specifically, the width of a loading space (the width formed in the y direction of FIG. 1) formed between the first support frame 31 disposed at the left side of the substrate loading cassette 100 and the first support frame 31 disposed at the right side of the substrate loading cassette 100 may be greater than the width of the target substrate. The depth of the loading space (the depth formed in the x direction of FIG. 1) may be greater than the length of the target substrate. As a result it is possible to prevent the target substrates from being contaminated or damaged due to contact with the frames.

The substrate loading cassette 100 includes a support bar 50 connected to the second support frame and having a shape extending inwardly of the substrate loading cassette. The support bar 50 will be described in more detail below.

The substrate loading cassette 100 may further include a cassette door 60 disposed on a front side thereof. The cassette door 60 may have the function of opening and closing the substrate loading cassette 100 and may serve to prevent the substrates loaded in the substrate loading cassette 100 from falling out of the cassette during the transfer process.

### Transfer Device Coupling Unit

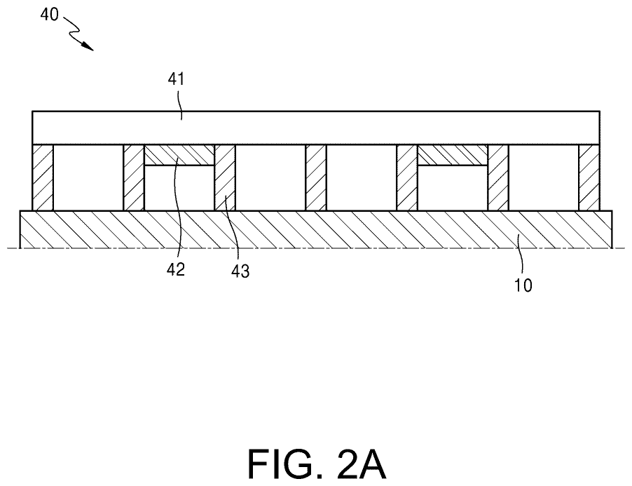

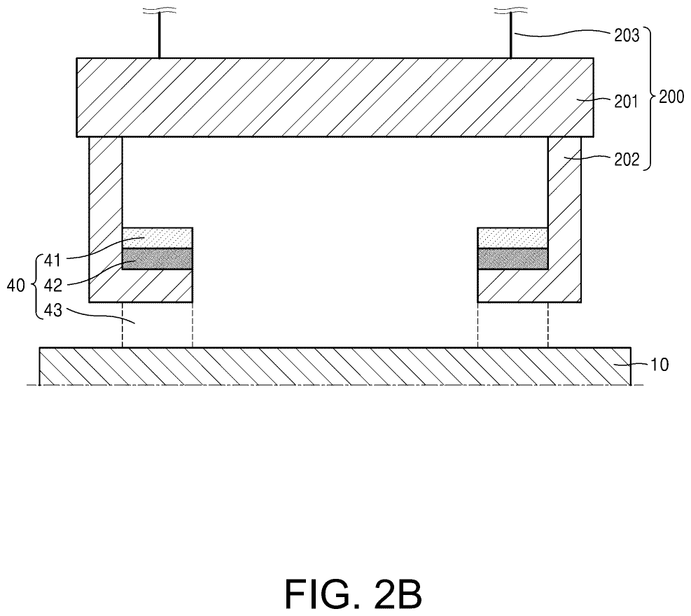

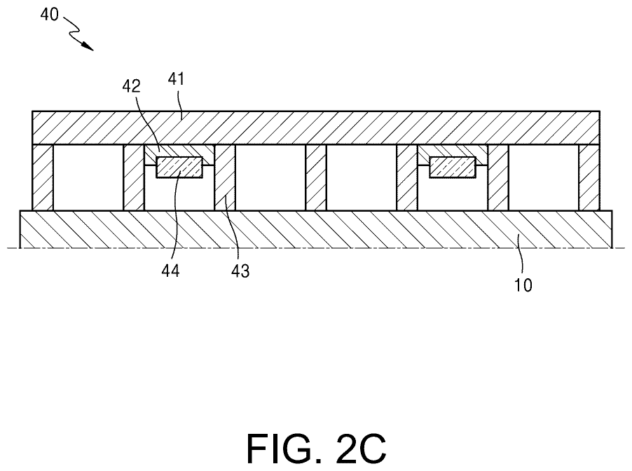

FIG. 2A is a sectional view illustrating a transfer device coupling unit applied to the substrate loading cassette according to the embodiment of the present disclosure. FIG. 2B is a sectional view showing the state in which the transfer device coupling unit is coupled to a gripping unit of a transfer device. The substrate loading cassette according to the present disclosure will be described with reference to FIGS. 2A and 2B.

The substrate loading cassette 100 may include a transfer device coupling unit 40 that is disposed on the upper frame 10 and is coupled to a transfer device 200 configured to transfer the substrate loading cassette 100. The transfer device 200 may include a main body 201, ropes 203 connected to an upper part of the main body 201, and a gripping unit 202 disposed under the main body 201.

The transfer device coupling unit 40 may be coupled to the gripping unit 202 of the transfer device 200 configured to transfer the substrate loading cassette 100, such as an OHT, such that the cassettes can be transferred by the OHT.

The transfer device coupling unit 40 may be provided in one or more so as to be disposed on the upper frame 10. When a plurality of transfer device coupling units 40 is applied to the substrate loading cassette 100, each transfer device coupling unit 40 may be disposed so as to face another transfer device coupling unit 40.

The transfer device coupling unit 40 may include a transfer device coupling frame 41 formed in the horizontal direction of the substrate loading cassette and a vibration damping portion 42 disposed under the transfer device coupling frame 41. The transfer device coupling unit 40 may further include a connecting frame 43 configured to connect the transfer device coupling frame 41 and the upper frame 10 to each other.

The vibration damping portion 42 may be disposed under the transfer device coupling frame 41 in contact therewith, or another component may be disposed between the vibration damping portion 42 and the transfer device coupling frame 41. The vibration damping portion 42 may be disposed in a region that is located in a lower surface of the transfer device coupling frame 41 and is recessed in the vertical direction. As a result, the vibration damping portion 42 may be stably fixed to the transfer device coupling frame.

When the substrate loading cassette 100 is lifted up after the transfer device coupling unit 40 is coupled to the gripping unit 202 of the transfer device 200, i.e., the OHT, an end of the gripping unit 202 may be disposed under the vibration damping portion 42 in contact therewith, and another component may be disposed between the end of the gripping unit 202 and the vibration damping portion 42.

While the substrate loading cassette 100 is being moved by the OHT, the load of the cassette may be concentrated on the transfer device coupling unit 40. As a result, vibration generated during the operation of the OHT may be transmitted to the cassette through the transfer device coupling unit 40. This may increase the possibility of damage to the substrates, each of which is thin and has a complex structure.

In the present disclosure, the vibration damping portion 42 may be applied to the transfer device coupling unit 40 to dampen vibration caused by the operation of the OHT to reduce the frequency of damage to the substrates loaded in the cassette.

The vibration damping portion 42 may include a polyamide resin. The polyamide resin may be any one selected from the group consisting of polycaprolactam (PA 6), polyundecanamide (PA 11), polylaurolactam (PA 12), polybutylene adipamide (PA 46), polyhexamethylene adipamide (PA 66), polyhexamethylene azelamide (PA 69), polyhexamethylene sebacamide (PA 610), polyhexamethylene dodecanediamide (PA 612), polydecamethylene dodecanediamide (PA 1012), polydecamethylene sebacamide (PA 1010), polydodecamethylene dodecanediamide (PA 1212), PA 11/NHUA, PA BACM6, PA BACM10, PA BACM12, PA 6/66, PA 6/12, which are polyamide copolymers, and a combination thereof. The polyamide resin may be polycaprolactam. The polyamide resin may be MC nylon resin.

In the present disclosure, the compression strength of the vibration damping portion 42 may be adjusted. This may enable the degree of deformation of the vibration damping portion 42 to be adjusted according to the load of the cassette loaded with the substrates, and may enable the gripping unit 202 of the OHT to be stably coupled to the transfer device coupling unit 40.

The compression strength of the vibration damping portion 42 is measured in accordance with ASTM D-695.

The compression strength of the vibration damping portion 42 may be 600 kg/cm² or more. The compression strength of the vibration damping portion 42 may be 700 kg/cm² or more. The compression strength of the vibration damping portion 42 may be 800 kg/cm² or more. The compression strength of the vibration damping portion 42 may be 850 kg/cm² or more. The compression strength of the vibration damping portion 42 may be 1,500 kg/cm² or less.

In this case, the cassette loaded with the substrates may be stably transferred by the OHT.

In the present disclosure, the elasticity of the vibration damping portion 42 may be adjusted within a predetermined range. This may enable more effective prevention of vibration caused by the operation of the OHT, and may enable the gripping unit 202 of the OHT to stably hold the cassette.

The tensile elasticity of the vibration damping portion 42 is measured in accordance with ASTM D-790.

The tensile elastic modulus of the vibration damping portion 42 may be 15,000 MPa to 50,000 MPa. The tensile elastic modulus of the vibration damping portion 42 may be 20,000 MPa or more. The tensile elastic modulus of the vibration damping portion 42 may be 25,000 MPa or more. The tensile elastic modulus of the vibration damping portion 42 may be 40,000 MPa or less.

In this case, vibration transmitted to the substrates loaded in the cassette may be effectively suppressed.

The vibration damping portion 42 may have a pad shape. The vibration damping portion 42 may have a pad shape with a recessed portion formed in a part thereof.

The vibration damping portion 42 may be fixed to the transfer device coupling frame 41 via a fastening means, such as an adhesive or a bolt. However, the means for fixing the vibration damping portion 42 to the transfer device coupling frame 41 is not limited thereto.

The area of the vibration damping portion 42 may be 1,000 mm² or more. The area of the vibration damping portion 42 may be 1,200 mm² or more. The area of the vibration damping portion 42 may be 1,500 mm² or more. The area of the vibration damping portion 42 may be 5,000 mm² or more. The area of the vibration damping portion 42 may be 10,000 cm² or less.

The thickness of the vibration damping portion 42 may be 1 mm or more. The thickness of the vibration damping portion 42 may be 2 mm or more. The thickness of the vibration damping portion 42 may be 3 mm or more. The thickness of the vibration damping portion 42 may be 20 mm or less. When the vibration damping portion 42 has a thickness that varies in an in-plane direction, the thickness of the vibration damping portion 42 is defined by the minimum thickness of the vibration damping portion 42.

In this case, the vibration damping portion 42 may stably protect the substrates from vibration caused by the operation of the OHT.

FIG. 2C is a sectional view illustrating a transfer device coupling unit applied to a substrate loading cassette according to another embodiment of the present disclosure. The substrate loading cassette according to the present disclosure will be described with reference to FIG. 2C.

The substrate loading cassette includes an upper frame, a lower frame disposed so as to face the upper frame, and a support frame configured to connect the upper frame and the lower frame to each other at an edge side of the substrate loading cassette. The substrate loading cassette includes a transfer device coupling unit which is disposed on the upper frame and to which a gripping unit of a transfer device configured to transfer the substrate loading cassette is coupled. The transfer device coupling unit includes a transfer coupling frame formed in the horizontal direction of the substrate loading cassette and a vibration damping portion disposed under the transfer coupling frame. The description given with reference to FIGS. 1, 2A, and 2B is equally applied to the specific configurations of the substrate loading cassette. The following description focuses on the differences.

The transfer device coupling unit 40 may further include a slip prevention portion 44 disposed under the vibration damping portion 42. When the transfer device coupling unit 40 is coupled to the gripping unit 202 of the transfer device, i.e., the OHT, the end of the gripping unit 202 may be disposed under the slip prevention portion 44 in contact therewith.

The slip prevention portion 44 may be disposed under the vibration damping portion 42 in contact therewith. Another component may be disposed between the slip prevention portion 44 and the vibration damping portion 42.

The slip prevention portion 44 may be disposed in a recessed region located under the vibration damping portion 42. In this case, the slip prevention portion 44 may be stably fixed to the vibration damping portion 42.

In the present disclosure, the coefficient of friction of the slip prevention portion 44 may be adjusted so as to be higher than the coefficient of friction of the vibration damping portion 42. This may enable the OHT to more stably hold the transfer device coupling unit 40, thereby preventing slippage during lifting or transfer of the cassette.

The slip prevention portion 44 may include any one selected from the group consisting of a rubber-based compound, a silicone rubber-based compound, and a combination thereof. The slip prevention portion 44 may be any one selected from the group consisting of a rubber-based compound, a silicone rubber-based compound, and a combination thereof.

For example, polyisoprene rubber, styrene-butadiene rubber, acrylonitrile-butadiene rubber, polychloroprene rubber, butyl rubber, or ethylene-propylene rubber may be used as the rubber-based compound.

The slip prevention portion 44 may have a pad shape. At least a part of the surface of the slip prevention portion 44 may be roughened so as to have a high coefficient of friction.

### Substrate Support Unit and Support Bar

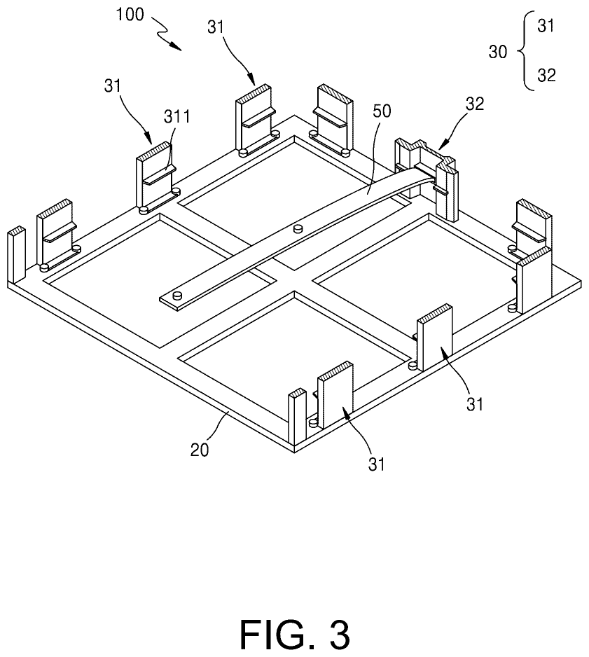

FIG. 3 is a sectional view taken along line I-I′ of FIG. 1. Hereinafter, the substrate loading cassette according to the embodiment will be described with reference to FIG. 3.

The substrate loading cassette includes an upper frame, a lower frame disposed so as to face the upper frame, and a support frame formed in the vertical direction of the substrate loading cassette to connect the upper frame and the lower frame to each other at an edge side of the substrate loading cassette. The substrate loading cassette includes a transfer device coupling unit which is disposed on the upper frame and to which a gripping unit of a transfer device configured to transfer the substrate loading cassette is coupled. The transfer device coupling unit includes a transfer coupling frame formed in the horizontal direction of the substrate loading cassette and a vibration damping portion disposed under the transfer coupling frame. The description given with reference to FIGS. 1, 2A, and 2B is equally applied to the specific configurations of the substrate loading cassette. The following description focuses on the differences.

The substrate loading cassette 100 may further include a substrate support unit 311 that is connected to the first support frame 31 and is formed inwardly of the substrate loading cassette 100. The substrate support unit 311 may support edges of target substrates loaded in the substrate loading cassette 100.

The substrate support unit 311 may include a base portion and a protective layer formed so as to surround at least a part of the base portion.

The base portion may be connected to the first support frame 31 in contact therewith. The base portion may be formed integrally with the first support frame 31. The material of the base portion may be the same as that of the first support frame 31.

The protective layer may be disposed in the region including the parts of the target substrates loaded in the substrate loading cassette in contact with the substrate support unit 311. This may enable adjusted elasticity to be imparted to the surface of the substrate support unit 311, thereby suppressing damage, such as scratches, to the surfaces of the target substrates caused by the substrate support unit 311.

A description of the composition of the protective layer will be omitted since the composition of the protective layer has already been previously described.

The substrate loading cassette 100 according to the present disclosure may further include a support bar 50 that is connected to the second support frame 32 and has a shape extending inwardly of the substrate loading cassette 100.

The support bar 50 may support the target substrates loaded in the cassette together with the substrate support unit 311. The support bar 50 may support the region of each target substrate located spaced apart from the region supported by the substrate support unit 311, especially a central portion of the target substrate. This may effectively prevent the central portion of the loaded target substrate from sagging downward during storage.

In addition, as the support bar 50 supports the central portion of the target substrate, the target substrate may be prevented from shaking horizontally in the cassette during loading and transfer of the target substrate. In addition, the target substrate may be prevented from colliding with or coming into contact with the support frame 30 of the cassette.

Additionally, in the present disclosure, the mechanical properties of the support bar 50 may be adjusted within a predetermined range. Vibration of the cassette generated during the lifting and transfer of the cassette by the OHT may be transmitted to the target substrates via the support bar 50 that supports the target substrates in contact therewith in the cassette. In the present disclosure, the support bar 50 with adjusted elasticity may be adopted, whereby it is possible to effectively dampen vibration transmitted to the target substrates via the support bar 50.

The modulus of elasticity of the support bar 50 may be 0.03 MPa to 0.5 MPa. The modulus of elasticity of the support bar 50 may be 0.04 MPa or more. The modulus of elasticity of the support bar 50 may be 0.05 MPa or more. The modulus of elasticity of the support bar 50 may be 0.3 MPa or less. The modulus of elasticity of the support bar 50 may be 0.2 MPa or less. The modulus of elasticity of the support bar 50 may be 0.1 MPa or less. In this case, the support bar 50 may dampen vibration caused by cassette transfer while suppressing sagging of the target substrates.

The modulus of elasticity is measured at room temperature in accordance with ASTM A370.

In the present disclosure, the Poisson's ratio and specific gravity of the support bar 50 may be simultaneously adjusted. The support bar 50 having the above features may have a weight less than a certain level while exhibiting minimal physical deformation (e.g., necking phenomenon) due to substrate load, thereby ensuring excellent long-term durability.

The Poisson's ratio of the support bar 50 may be 0.4 or less. The Poisson's ratio of the support bar 50 may be 0.35 or less. The Poisson's ratio of the support bar 50 may be 0.32 or less. The Poisson's ratio of the support bar 50 may be 0.3 or less. The Poisson's ratio of the support bar 50 may be 0.2 or more.

The Poisson's ratio is measured at room temperature in accordance with ASTM A370.

The specific gravity of the support bar 50 may be 1.2 to 1.8. The specific gravity of the support bar 50 may be 1.7 or less. The specific gravity of the support bar 50 may be 1.65 or less. The specific gravity of the support bar 50 may be 1.62 or less.

In this case, the support bar 50 may stably support the target substrates loaded in the substrate loading cassette for a long period of time.

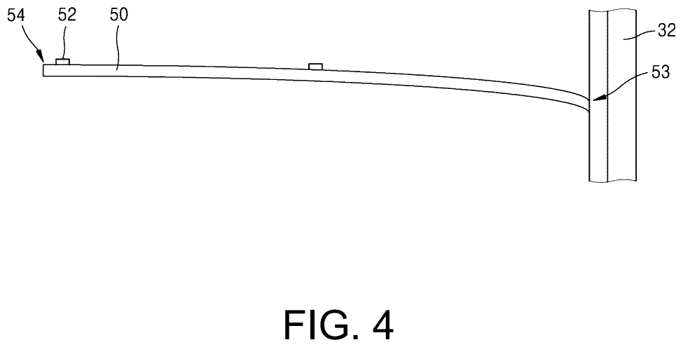

FIG. 4 is a side view showing the support bar of FIG. 1. Hereinafter, the embodiment will be described with reference to FIG. 4.

The support bar 50 may include a first end 53 located on the second support frame 32 side and a second end 54 located on the opposite side to the first end 53. The second end 54 may be located higher than the first end 53.

When viewed from the side, the height of the support bar 50 may gradually increase in the direction from the first end 53 to the second end 54. When viewed from the side, the support bar 50 may have a curved shape or a straight shape forming a slope. In this case, the contact area between the target substrate and the support bar 50 may be reduced to a certain level or less, thereby reducing the possibility of contamination of the target substrate due to contact with the support bar 50.

The difference between the height of the second end 54 when the support bar 50 supports the target substrate and the height of the second end 54 before the support bar 50 supports the target substrate may be 3 mm or less. The difference may be 2 mm or less. The difference may be 1.5 mm or less. The difference may be 0.1 mm or more. In this case, the support bar 50 having the elastic characteristics described above and the substrate support unit 311 may stably support the target substrates together.

The material of the support bar 50 is not limited as long as the material is commonly used in the field of substrate loading cassettes. For example, the material of the support bar 50 may be carbon fiber-impregnated epoxy resin or glass fiber-reinforced plastic.

The substrate loading cassette 100 according to the present disclosure may further include a substrate support member 52 that is disposed on the support bar 50 and protrudes upward.

When the target substrates are loaded in the substrate loading cassette 100, the substrate support member 52 may be in contact with the surfaces of the target substrates to support the target substrates. The substrate support member 52 may have the function of reducing the contact area between the support bar 50 and the target substrate. The substrate support member 52 may have a convex shape. In this case, the contact area between the support bar 50 and the target substrate may be further reduced, thereby effectively lowering the possibility of contamination of the target substrate.

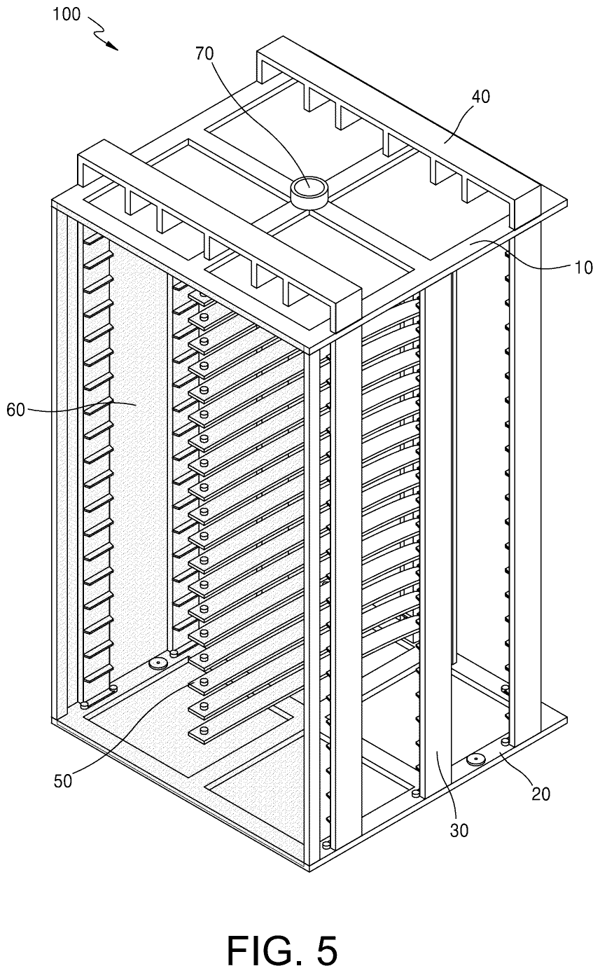

FIG. 5 is a perspective view showing a substrate loading cassette according to a further embodiment of the present disclosure. The present disclosure will be described with reference to FIG. 5.

The substrate loading cassette includes an upper frame, a lower frame disposed so as to face the upper frame, and a support frame formed in the vertical direction of the substrate loading cassette to connect the upper frame and the lower frame to each other at an edge side of the substrate loading cassette. The substrate loading cassette includes a transfer device coupling unit which is disposed on the upper frame and to which a gripping unit of a transfer device configured to transfer the substrate loading cassette is coupled. The transfer device coupling unit includes a transfer coupling frame formed in the horizontal direction of the substrate loading cassette and a vibration damping portion disposed under the transfer coupling frame. The description given with reference to FIGS. 1 to 4 is equally applied to the specific configurations of the substrate loading cassette. The following description focuses on the differences.

The substrate loading cassette according to the further embodiment may further include a guide block 70 disposed on the upper frame.

The guide block 70 of the substrate loading cassette 100 may have a structure that engages with a guide block (not shown) included in a main body of the transfer device. The guide block 70 of the substrate loading cassette 100 may guide the main body of the transfer device approaching from above the cassette to a predetermined position. As a result, the gripping unit of the transfer device may be accurately fastened to the transfer device coupling unit at the predetermined position (specifically, the vibration damping portion or the slip prevention portion), and the possibility of the cassette 100 falling out of the transfer device or excessive vibration occurring in the cassette 100 during the transfer of the cassette may be reduced.

Although the embodiments have been described in detail above, the scope of the present disclosure is not limited thereto, and various modifications and improvements by those skilled in the art utilizing the basic concepts of the present disclosure defined in the following claims are also within the scope of the present disclosure.

What is claimed is:

1. A substrate loading cassette, comprising:
an upper frame;
a lower frame disposed to face the upper frame;
a support frame formed in a vertical direction of the substrate loading cassette, the support frame being configured to connect the upper frame and the lower frame to each other at an edge side of the substrate loading cassette;
a transfer device coupling unit disposed on the upper frame, the transfer device coupling unit being coupled to a transfer device configured to transfer the substrate loading cassette, wherein
the transfer device coupling unit comprises a transfer device coupling frame formed in a horizontal direction of the substrate loading cassette and a vibration damping portion disposed under the transfer device coupling frame,
the support frame comprises a first support frame disposed on each of left and right sides of the substrate loading cassette and a second support frame disposed on a rear side of the substrate loading cassette,
the substrate loading cassette comprises a support bar connected to the second support frame, the support bar having a shape extending inwardly of the substrate loading cassette,
the vibration damping portion comprises polyamide resin,
the vibration damping portion has a compression strength of 600 kg/cm² or more, and
the support bar has a modulus of elasticity of 0.03 MPa to 0.5 MPa.

2. The substrate loading cassette according to claim 1, wherein
the support bar has a Poisson's ratio of 0.4 or less, and
the support bar has a specific gravity of 1.2 to 1.8.

3. The substrate loading cassette according to claim 1, wherein the vibration damping portion has a tensile elasticity of 15,000 MPa to 50,000 MPa.

4. The substrate loading cassette according to claim 1, wherein
the transfer device coupling unit further comprises a slip prevention portion disposed under the vibration damping portion, and
the slip prevention portion has a coefficient of friction higher than the coefficient of friction of the vibration damping portion.

5. The substrate loading cassette according to claim 1, comprising:
a substrate support unit connected to the first support frame, the substrate support unit being formed inwardly of the substrate loading cassette, wherein
the substrate support unit comprises a base portion and a protective layer formed to surround at least a part of the base portion.

6. The substrate loading cassette according to claim 5, wherein the protective layer comprises any one selected from a group consisting of polytetrafluoroethylene, fluorinated ethylene propylene, polyetheretherketone, polyetherimide, polyethersulfone, perfluoroalkoxy copolymer, polyaryletherketone, and a combination thereof.

7. The substrate loading cassette according to claim 1, comprising a guide block disposed on the upper frame.

8. The substrate loading cassette according to claim 1, wherein
the support bar comprises a first end located on the second support frame side and a second end located on an opposite side to the first end,
the second end is located higher than the first end, and
a difference between the height of the second end when the support bar supports a target substrate and the height of the second end before the support bar supports the target substrate is 3 mm or less.

9. The substrate loading cassette according to claim 1, comprising:
a substrate support member disposed on the support bar, the substrate support member protruding upward, wherein
the substrate support member has a convex shape.
